(19) United States
(12) Patent Application Publication
(10) Pub. No.: US 2002/0168940 A1
(43) Pub. Date: Nov. 14, 2002

(54) Predictive fair polling mechanism in a wireless access scheme

(76) Inventors: Geert Heijenk, Enschede (NL); Rachid Ait Yaiz, Apeldoorn (NL)

Correspondence Address: JENKENS & GILCHRIST, PC, 1445 ROSS AVENUE, SUITE 3200, DALLAS, TX, 75202, US

(21) Appl. No.: 09/954,780

(22) Filed: Sep. 17, 2001

Related U.S. Application Data
(60) Provisional application No. 60/241,314, filed on Oct. 18, 2000.

(51) Int. Cl. H04B 5/00

(52) U.S. Cl. 455/41; 455/422

(57) ABSTRACT

Method and system for controlling access to a communication channel. The method involves calculating an efficiency value for each communication device of a plurality of communication devices, calculating a fairness value for each communication device of the plurality of communication devices, and providing each of the plurality of communication devices with access to the communication channel based on a result of the calculations. The method considers both efficiency and fairness in deciding which of the plurality of communication devices to select thus providing a system designer with the ability to achieve a good compromise between efficiency and fairness. The system includes a slave tracker within a master communication device for performing the calculations and for deciding which of the plurality of slave communication devices to give access to the communication channel.

### CROSS-REFERENCE TO RELATED APPLICATIONS

This U.S. Nonprovisional Application for Patent claims the benefit of priority from, and hereby incorporates by reference the entire disclosure of, co-pending U.S. Provisional Application for Patent Serial No. 60/241,314, filed Oct. 18, 2000.

### BACKGROUND OF THE INVENTION

1. Technical Field of the Invention

This invention relates generally to the telecommunications field; and, more particularly, to a predictive fair polling mechanism used in a wireless access scheme.

2. Description of the Related Art

In many communications technologies, a plurality of communication devices share a common communication channel (CCCH). Successful communication occurs when one device utilizes the CCCH at a time. To facilitate successful communication, several mechanisms exist to control access to the CCCH; and one common access control mechanism is known as polling. In polling, one of the plurality of devices functions as a master device, and the other devices function as slave devices. A slave device is allowed to transmit on the CCCH only after it has been polled by the master device. In one common polling procedure (referred to as “explicit” polling), the master device polls a slave device by sending a special poll packet to the slave device. In another polling procedure (referred to as “implicit” polling), the sending of a data packet from the master device to the slave device is interpreted as a poll by the slave device. In an access control mechanism that utilizes both explicit and implicit polling, a slave device is allowed to transmit on the CCCH after receiving any type of packet from the master device.

After being polled, a slave device may transmit data on the CCCH. If the slave device has no data to transmit; it may send an empty packet to the master device or it may transmit no data at all, depending on the specific polling mechanism.

One example of a communications technology that uses polling is Bluetooth radio technology. Bluetooth technology allows users to make wireless connections between various communication devices such as mobile phones, printers, laptop computers and the like. In a Bluetooth system, one master device and up to seven slave devices can be affiliated with each other; and form what is referred to as a “piconet”. A piconet is, in effect, a wireless network in which all the devices in the piconet are able to communicate with one another. The master device utilizes its clock and hopping sequence to synchronize the slave devices. The Bluetooth system is a slotted access mechanism that divides each second into 1600 time slots. The time slots are either downlink slots or uplink slots. The master device uses the downlink slots to transmit to a slave device, and the slave devices use the uplink slots to transmit to the master device.

Traffic within a piconet is controlled by the master device of that particular piconet. A slave device is allowed to transmit data if it was polled by the master device in the previous time slot. In other words, the master device polls the slave device in order to allow the slave device to transmit data, if it has data to transmit. The master device may poll the slave devices of its piconet using either explicit polling or implicit polling. Thus, if the master device has no data to transmit but still wants to give a slave device an opportunity to transmit data back to the master device; the master device sends a data packet with no payload to the slave device. If the master device has data to transmit to the slave device, the slave device has the opportunity to transmit data back to the master device after it receives the data sent by the master device.

Communications technologies such as Bluetooth technology utilize a variety of polling mechanisms which differ from one another primarily in the manner in which the slave devices are polled, and in the service discipline used to serve a slave device. For example, in “round robin polling”, slave devices are polled one after another in a cyclical manner. In one version of round robin polling, referred to as “1-limited round robin polling”, slaves are polled in sequence and each may send a single unit (packet) of data upon being polled. Thus, in a piconet having one master device and seven slave devices, each slave device receives one-seventh of the available polls from the master device in a 1-limited round robin polling procedure.

A disadvantage of 1-limited round robin polling is that it is often inefficient. In particular, lightly loaded slave devices will receive the same amount of polls as heavily loaded slave devices. As a result, a significant number of the polls may be wasted because the lightly loaded slave devices will often have no data to transmit; while, at the same time, the heavily loaded slave devices may not receive a sufficient number of polls to be able to transmit all of their data in a timely fashion.

A second polling mechanism, referred to as “fair exhaustive polling”, was developed to improve upon the inherent inefficiencies associated with round robin polling. In fair exhaustive polling, slave devices are divided into two groups, active and inactive. Slave devices in the active group are polled in a round robin manner, while slave devices in the inactive group are polled periodically but less frequently than the slave devices in the active group. The activity of a slave device may be measured by monitoring the number of successive useless polls, or the average success rate of polls. If the success rate of a particular slave device in the active group falls below a predetermined level, the slave device is moved from the active group to the inactive group. Similarly, if the success rate of a slave device in the inactive group exceeds a predetermined threshold, the slave device is moved from the inactive group to the active group.

Although the fair exhaustive polling mechanism improves upon the success of the round robin polling mechanism, fair exhaustive polling still encounters several drawbacks. For example, the efficiency of fair exhaustive polling relies on the assumption that slave devices are either inactive or heavily loaded at a particular moment; and this may not always be the case. At certain instances, for example, the slave devices may all be partially loaded; and the fair exhaustive polling approach will be less efficient and less fair to at least some of the plurality of slave devices in such circumstances. Efficiency will also be decreased and unfairness will result if a slave device becomes heavily loaded or extremely lightly loaded for a short amount of time. In such circumstances, it may take several rounds of polls before the success rate of a slave device experiencing short bursts of extreme activity or inactivity changes enough to move the slave device from the inactive group to the active group or vice versa. Also, quality of service parameters are not taken into consideration in the fair exhaustive polling approach.

Another mechanism used to control access to a communication channel is known as “scheduling”. In scheduling, a scheduler will assign resources (e.g., channel time) to certain jobs (e.g., packet transmissions), which arrive from different queues. A major distinction between polling and scheduling is that, in scheduling, the scheduler has complete knowledge about the jobs requiring service; whereas in polling, the master device does not know anything about the packets (jobs) waiting at the slave devices. Furthermore, there is usually no time involved in scheduling a certain job; whereas polling a slave device for data costs a certain amount of channel time if there is no data to transmit in an implicit poll. Sophisticated algorithms have been designed for scheduling to guarantee fairness to the different streams of packets arriving in the system. Virtual clock scheduling is one such mechanism.

In general, there is a need in the telecommunications field for a polling mechanism that is both efficient, so as to minimize wasted bandwidth, and fair, so as to provide each of a plurality of slave devices with an appropriate opportunity to transmit data.

### SUMMARY OF THE INVENTION

The present invention provides a method and system for controlling access to a communication channel that is both efficient and fair. More particularly, a method for controlling access to a communication channel in a communication system according to the present invention includes the steps of calculating an efficiency value for each communication device of a plurality of communication devices, calculating a fairness value for each communication device of the plurality of communication devices, and providing each of the plurality of communication devices with access to the communication channel based on a result of the calculating steps.

In accordance with the present invention, access to the communication channel by each of a plurality of communication devices is based upon a consideration of a measure of efficiency and of a measure of fairness. This enables a system designer to configure the system to achieve a good compromise between efficiency and fairness such that each of the plurality of communication devices in the system will be provided with appropriate access to the communication channel.

According to one embodiment of the present invention, the plurality of communication devices comprise a plurality of slave communication devices and the communication system further includes a master communication device that controls access to the communication channel by the plurality of slave communication devices by a polling procedure in which the master communication device polls the plurality of slave communication devices in accordance with a result of the calculating steps.

In general, the present invention recognizes that currently used polling mechanisms tend to be either efficient (e.g., fair exhaustive polling) or fair (e.g., round robin polling). In order to be efficient, the number of polls resulting in no data being transmitted from a slave device to the master device should be minimized; and, in addition, the use of explicit polling should be minimized (i.e., polling should be performed in conjunction with the transmission of data from the master device to a slave device as much as possible).

To be fair, each slave device should receive its fair share of polls. What is fair depends largely on the situation. For example, if each of the plurality of slave devices is substantially equally loaded, fairness will usually dictate that each slave device receive an equal number of polls. On the other hand, if some slave devices are more active than others, fairness might dictate that the more active devices receive a greater number of polls than the less active devices. In yet other situations, fairness might call for the number of polls to be divided according to one or more specified parameters such as, for example, Quality of Service.

According to a presently preferred embodiment of the invention, the efficiency value is based, at least in part, on the presence of data to send from the master communication device to the slave communication devices, and an estimate of the probability that a slave communication device has data to transmit on the communication channel after it is polled. The fairness value is based, at least in part, on an expression of the service received by the slave communication devices in accordance with a predetermined definition of fairness. Such predetermined definition of fairness may be based on agreed to Quality of Service requirements and on other factors. Based on the calculated efficiency value and the calculated fairness value, the master communication device makes a decision about which slave communication device to poll.

The present invention also provides a system for controlling access to a communication channel. According to a presently preferred embodiment of the invention, the system comprises a poller, referred to herein as a “Predictive Fair Poller”, that is incorporated in a master communication device. The poller includes a slave selector which selects the next slave communication device to poll. The slave selector includes a fair share determinator for determining a fair share of bandwidth for at least one of the plurality of slave communication devices, a decision maker for determining the next slave communication device to be polled, and at least one slave status tracker for transmitting, to the decision maker, a fraction of the fair share of bandwidth and a probability of data being available to transmit for at least one of the plurality of slave communication devices. Each slave status tracker preferably also includes a fraction of fair share estimator for estimating the fraction of the fair share of bandwidth, a data availability predictor for predicting the probability of data being available to transmit for at least one of the plurality of slave communication devices, and a traffic demand estimator for estimating a traffic demand for at least one of the slave status trackers.

Yet further advantages and specific features and details of the present invention will become apparent hereinafter in conjunction with the following detailed description of presently preferred embodiments of the invention.

### BRIEF DESCRIPTION OF THE DRAWINGS

FIG. 1 schematically illustrates a known wireless telecommunications system to assist in explaining the present invention;

FIG. 2 is a block diagram that schematically illustrates a slave selector for controlling access to a communication channel according to a presently preferred embodiment of the invention;

FIG. 3 is a block diagram that schematically illustrates a slave status tracker included in the slave selector of FIG. 2;

FIG. 4 is a graph illustrating waiting time in a lowly loaded piconet;

FIG. 5 is a graph illustrating fairness based on an inverse fraction of fair waiting time in a lowly loaded piconet;

FIG. 6 is a graph illustrating efficiency in a highly loaded piconet;

FIG. 7 is a graph illustrating fairness based on fraction of fair share in a highly loaded piconet;

FIG. 8 is a graph illustrating waiting time in a highly loaded piconet;

FIG. 9 is a graph illustrating fairness based on an inverse fraction of fair waiting time in a highly loaded piconet; and

FIG. 10 is a flow chart illustrating steps of a method for controlling access to a communication channel according to a presently preferred embodiment of the invention.

### DETAILED DESCRIPTION OF PRESENTLY PREFERRED EMBODIMENTS

Although the following detailed description describes embodiments of the present invention with reference to Bluetooth radio technology, it is to be understood that the present invention is not intended to be limited thereto but may be applied to other telecommunications technologies and systems that involve controlling access to a communication channel.

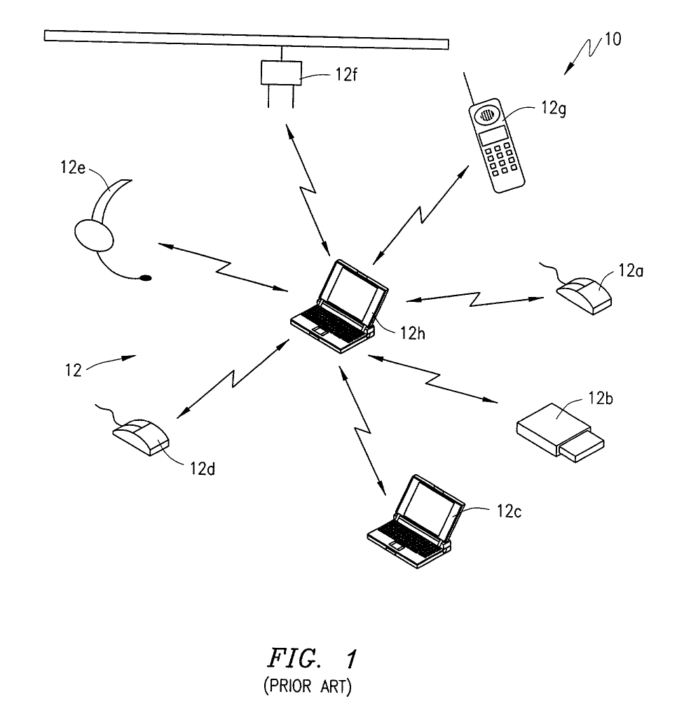

FIG. 1 schematically illustrates a Bluetooth telecommunications system in order to assist in explaining the present invention. The system is generally designated by reference number 10, and comprises a plurality of portable electronic devices, generally designated by reference number 12, that are connected together in a wireless manner so as to be able to communicate with one another. As shown in FIG. 1, the plurality of devices may comprise, for example, one or more laptop computers, mouses, printers, headsets and access points to a LAN or the like. In a Bluetooth system, each device can communicate with up to seven other devices.

In a Bluetooth system, one of the plurality of devices 12, i.e., device 12h, functions as a master device; and the remaining plurality of devices, i.e., devices 12a-12g, function as slave devices. The plurality of affiliated devices 12a-12h form a piconet. Traffic within the piconet is controlled by the master device 12h, and a slave device is allowed to transmit data only if it was polled by the master device in the previous time slot. As discussed previously, the master device may poll the slave devices in the piconet using either explicit polling or implicit polling.

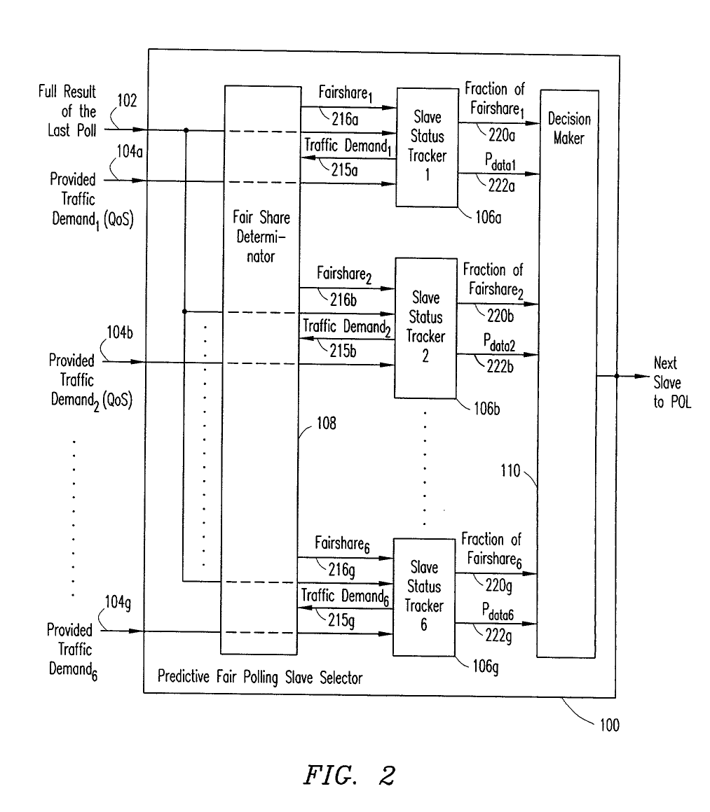

As also discussed previously, known polling mechanisms tend to be either efficient (e.g., fair exhaustive polling) or fair (e.g., round robin polling) when deciding which slave device to next poll, but not both. The present invention, on the other hand, provides a polling mechanism, referred to herein as “predictive fair polling” (PFP) which considers both efficiency and fairness when deciding which slave device to next poll; and FIG. 2 schematically illustrates a predictive fair polling system according to a presently preferred embodiment of the present invention.

As shown in FIG. 2, the PFP system comprises a slave selector, generally designated by reference number 100, which is preferably located in the master device 12h; and which functions to determine the next one of the plurality of slave devices 12a-12g in the piconet to be polled. Inputs to the slave selector 100 include results of previous poll decisions, on line 102; and provided traffic demand (TD) for each slave device, shown as inputs 104a, 104b . . . 104g. As will be described more fully hereinafter, results of the previous poll decisions input on line 102, and the provided traffic demands input on lines 104a . . . 104g are input to slave status trackers 106a . . . 106g in the slave selector 100. Each slave status tracker is associated with one of the plurality of slave devices.

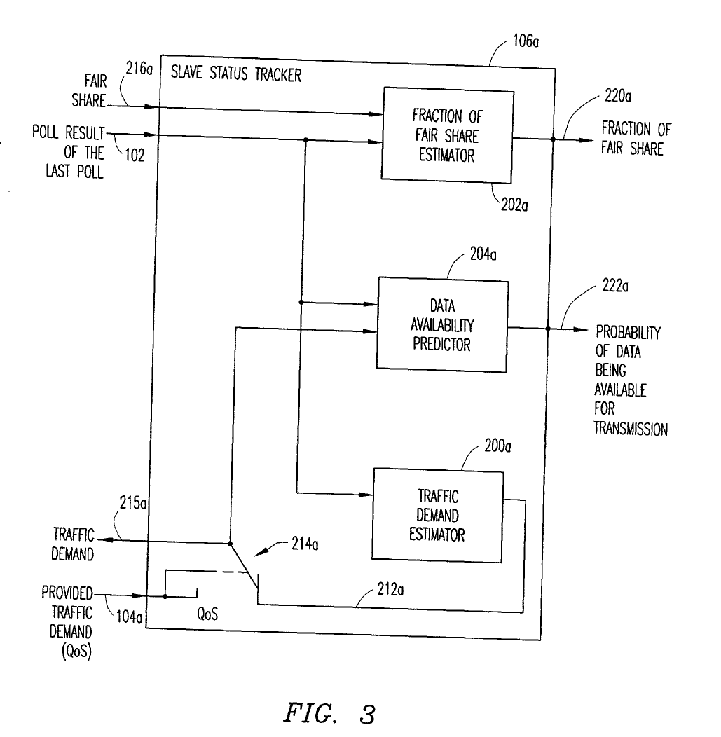

FIG. 3 illustrates one of the slave status trackers 106a shown in FIG. 2 in greater detail. The remaining slave status trackers 106b-106g are identical and, therefore, are not described herein. Slave status tracker 106a includes a traffic demand estimator 200a for estimating the traffic demand of its associated slave device 12a. As shown in FIG. 3, the traffic demand estimator 200a is adapted to receive information concerning the results of the last poll from line 102, and output an estimate of traffic demand for its associated slave device on line 212a. The slave status tracker 106a also includes a selector 214a, and, depending on the status of the selector 214a; either the provided traffic demand input on line 104a or the estimated traffic demand on line 212a is sent to a fair share determinator 108 in the slave status tracker 100 (see FIG. 2) via traffic demand output line 215a. Thus, if a traffic demand is provided from slave device 12a on line 104a, that signal is sent to the fair share determinator 108 via the selector 214a. If a traffic demand is not provided by slave device 12a, the estimated traffic demand for that slave device is sent from the traffic demand estimator of the slave status tracker to the fair share determinator 108 via the selector 214a. The traffic demand information sent from the slave status tracker is then used by the fair share determinator to calculate a fair share of bandwidth for the slave device as will be described hereinafter.

Slave status tracker 106a also includes a fraction of fair share estimator 202a which receives the fair share calculated by the fair share determinator 108 on line 216a and the poll result of the last poll from input 102. Using this information, the fraction of fair share estimator 202a determines the fraction of the fair share of bandwidth that slave device 12a has been given. The fraction of fair share estimator 202a sends the fraction of the fair share of bandwidth to a decision maker 110 ( FIG. 2) on line 220a in order to assist the decision maker in determining which slave device to poll next.

The slave status tracker 106a also includes a data availability predictor 204a which receives inputs from results of the last poll on line 102 and the traffic demand (either the provided traffic demand on line 104a or the estimated traffic demand on line 212a), and utilizes that information to calculate the probability of data being available for transmission (P_{data}). The results of the data availability predictor 204a are passed to the decision maker 110 on line 222a to further assist the decision maker in deciding which slave device to poll next.

Returning to FIG. 2, and as indicated above, the fair share determinator 108 determines a fair share of bandwidth for each of the slave devices, and this information is then passed to a respective slave status tracker 106a-106g from the fair share determinator on lines 216a . . . g. The slave status trackers 106a-106g send the fraction of the fair share of bandwidth for their associated slave device, as well as a probability of data being available for transmission from their associated slave device (P_{data1}, P_{data2}, P_{data6}), to decision maker 110. The decision maker110 decides which slave device to poll next based on the information received from the status slave trackers 106a-106g and also based on decision rules that define requirements for both efficiency and fairness.

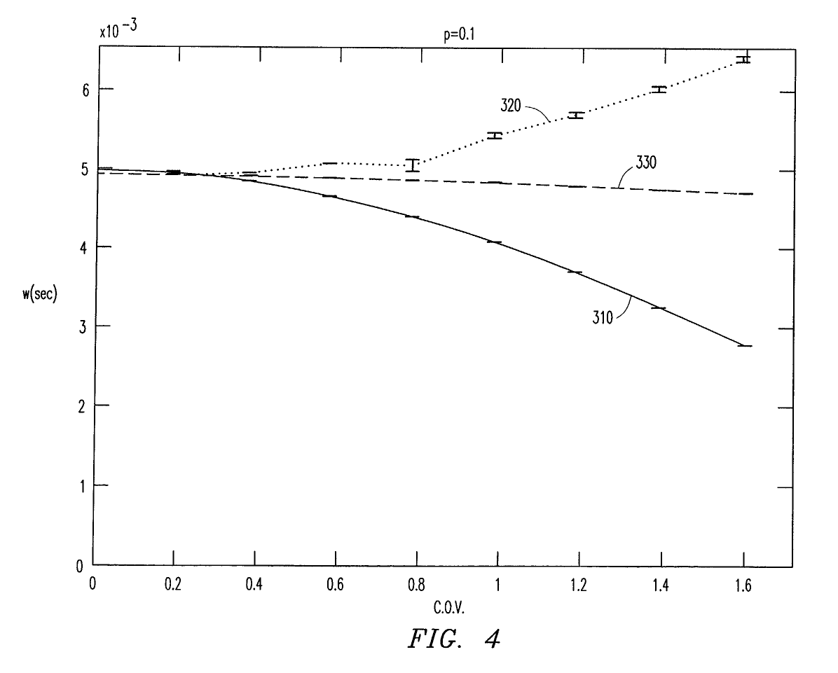

FIGS. 4-9 are graphs which illustrate results of simulations conducted using a round robin poller, a fair exhaustive poller and a predictive fair poller according to the present invention. Initially, FIG. 4 is a graph which illustrates the waiting time in a lowly loaded piconet. The x-axis represents the coefficient of variation (COV) in the arrival rate, and the y-axis represents the waiting time “W” in seconds. As shown in the graph, the waiting time when using a fair predictive poller (line 310) according to the present invention decreases as the COV increases; while the waiting time when using a round robin poller (line 320) increases when the COV increases, and the waiting time when using the fair exhaustive poller (line 330) holds substantially steady as the COV increases. Accordingly, the predictive fair poller of the present invention out performs both the fair exhaustive poller and the round robin poller with respect to waiting time in a lowly loaded piconet.

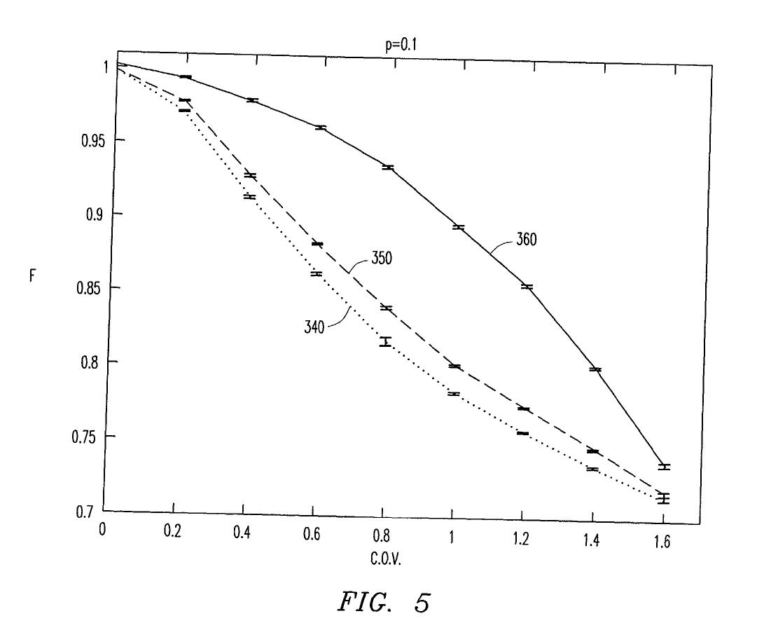

FIG. 5 is a graph which illustrates fairness “F” based on an inverse fraction of fair waiting time (represented by the y-axis) versus COV in a lowly loaded piconet. As shown in FIG. 5, the fairness of the round robin poller (line 340) and the fair exhaustive poller (line 350) steadily decreases as the COV increases, whereas the fair predictive poller of the present invention (line 360) remains fairer as the COV increases.

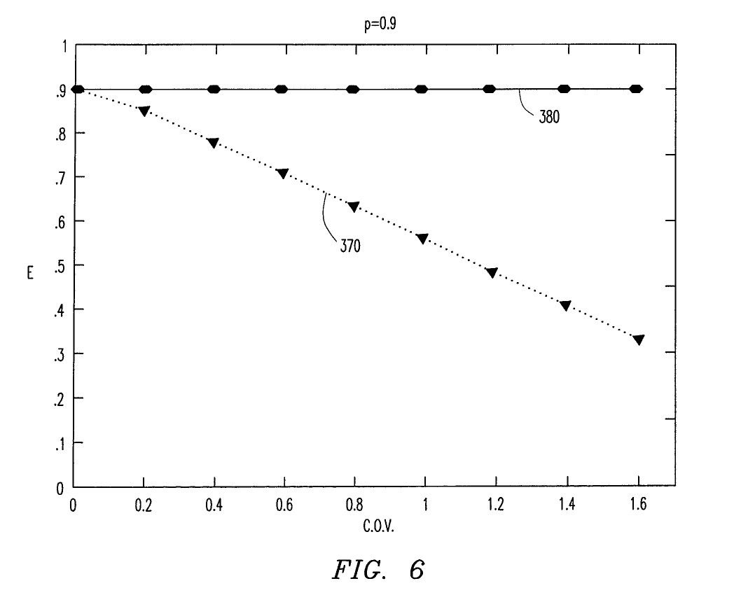

FIG. 6 is a graph which illustrates efficiency “E” in a highly loaded piconet. As illustrated, a round robin poller (line 370) becomes increasingly inefficient for increasing values of the COV, while both the predictive fair poller and the fair exhaustive poller (line 380) achieve a maximum possible efficiency.

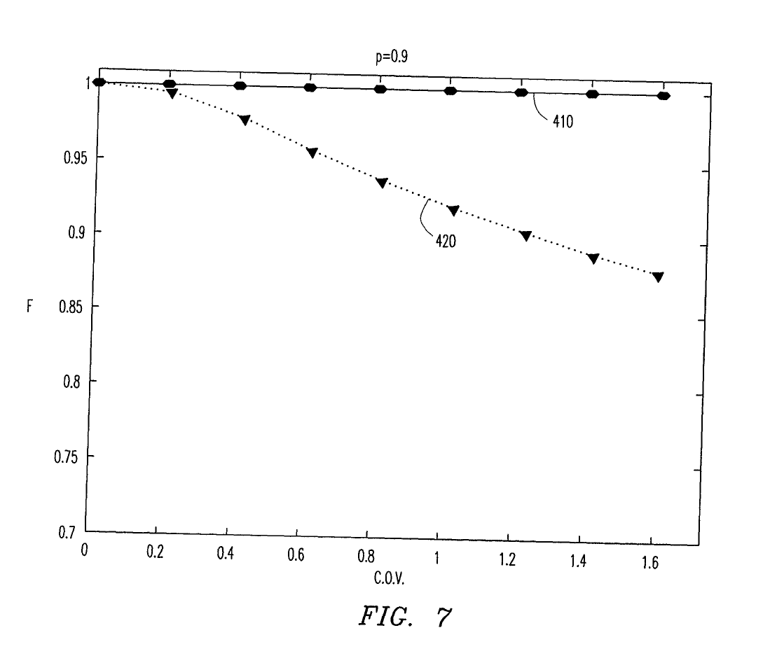

FIG. 7 is a graph which illustrates fairness “F” based on a fraction of fair share in a highly loaded piconet. Based on the fraction of fair share of bandwidth for each slave device (y-axis), the predictive fair poller and the fair exhaustive poller both achieve maximum fairness (line 410). In contrast, the round robin poller becomes unfair based on the fractions of fair share for increasing values of the COV (line 420).

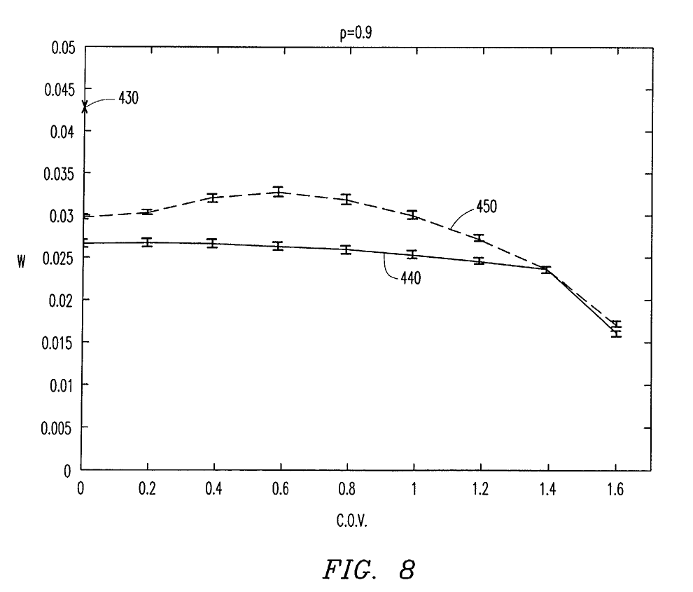

FIG. 8 is a graph which illustrates the waiting time “W” in a highly loaded piconet. As illustrated at 430, the round robin poller becomes exceedingly unstable as the COV increases. As also shown in FIG. 8, the waiting time is less for a system using the predictive fair poller (line 440) than for a system using the fair exhaustive poller (line 450).

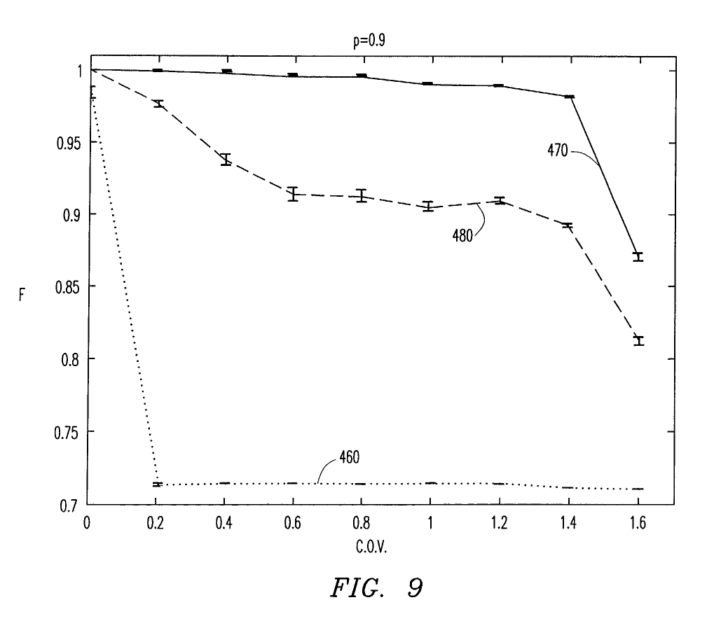

FIG. 9 is a graph which illustrates fairness based on inverse fraction of fair waiting time in a highly loaded piconet. As shown, for increasing values of the COV, the round robin poller becomes unstable (line 460), and the waiting time for the predictive fair poller (line 470) is less than that of the fair exhaustive poller (line 480).

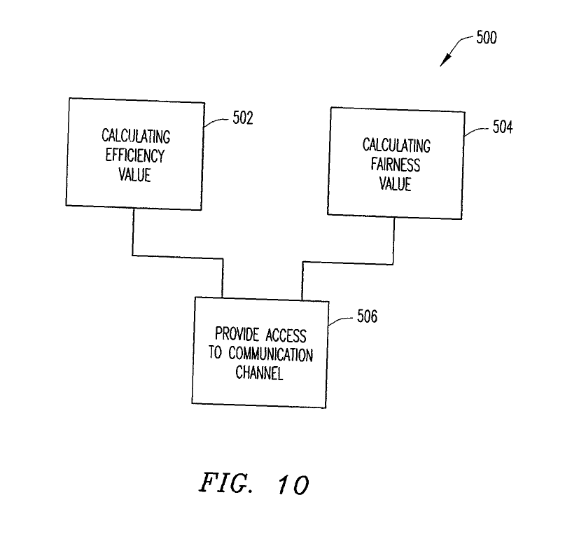

FIG. 10 is a flow chart which illustrates a method 500 for controlling access to a communication channel in a communication system such as illustrated in FIG. 1, utilizing a predictive fair polling slave selector such as illustrated in FIG. 2. As shown in FIG. 10, an efficiency value for each of the slave communication units 12a-12g is calculated in step 502. As indicated previously, this calculation can be made based on traffic demands made by the slave devices or on estimates of the traffic demand for each slave device that does not make a traffic demand. A fairness value for each of the plurality of slave devices is also calculated in step 504. As indicated previously, the fairness value can be based on a predetermined definition of fairness, and may be based on agreed to Quality of Service requirements as well as on other factors. Following the calculations in steps 502 and 504, each of the plurality of slave devices is provided with access to the communication channel based on the results of the calculating steps as shown in step 506.

With the predictive fair poller of the present invention, a system designer can configure the poller to obtain a good compromise between efficiency and fairness. Generally speaking, the polling method and system according to the present invention is both efficient and fair. The polling mechanism also allows the slave devices to be provided with a certain pre-negotiated Quality of Service, and to make use of an agreement about offered traffic, in order to utilize the communication channel more efficiently. Furthermore, the polling mechanism according to the present invention can be used to force slave devices not to send out more data than what was agreed on.

It should be emphasized that the term “comprises/comprising” when used in this specification is taken to specify the presence of stated features, integers, steps or components but does not preclude the presence or addition of one or more other features, integers, steps, components or groups thereof.

Although exemplary embodiments of a method and system of the present invention have been illustrated in the accompanying drawings and described in the foregoing Detailed Description, it is to be understood that the invention is not limited to the embodiments disclosed; but that the invention can be varied in numerous ways. It should, accordingly, be recognized that the invention should be limited only insofar as is required by the scope of the following claims.

What is claimed is:

1. A method for controlling access to a communication channel in a communication system, comprising the steps of:
calculating an efficiency value for each communication device of a plurality of communication devices;
calculating a fairness value for each said communication device of said plurality of communication devices; and
providing each of said plurality of communication devices with access to said communication channel based on a result of the calculating steps.

2. The method of claim 1, wherein the calculating and providing steps are performed by a slave selector in a master communication device, and wherein said plurality of communication devices comprise a plurality of slave communication devices.

3. The method of claim 2, wherein said providing step comprises said master communication device polling each of said plurality of slave communication devices based on a result of said calculating steps.

4. The method of claim 3, wherein said step of calculating an efficiency value for each slave communication device comprises calculating an efficiency value based, at least in part, on at least one of the presence of data to send from said master communication device to a slave communication device, and either a traffic demand message sent from a slave communication device to the master communication device or an estimate of the probability that a slave communication device has data to send to the master communication device.

5. The method of claim 3, wherein said step of calculating a fairness value for each slave communication device comprises calculating a fairness value based on a predetermined definition of fairness.

6. The method of claim 5, wherein said predetermined definition of fairness includes agreed to Quality of Service requirements.

7. The method of claim 1, wherein said communication system comprises a Bluetooth communication system.

8. A method for controlling access to a communication channel, comprising the steps of:
calculating an efficiency value for each communication device of a plurality of communication devices;
calculating a fairness value for each said communication device of said plurality of communication devices; and
selecting a first communication device from said plurality of communication devices to be provided access to said communication channel based on a result of said calculating steps.

9. The method of claim 8, wherein said calculating steps and said selecting step are performed by a slave selector in a master communication device, and wherein said plurality of communication devices comprise a plurality of slave communication devices.

10. The method of claim 9, wherein said selecting step comprises selecting the first slave communication device to poll based on a result of said calculating steps.

11. The method of claim 10, wherein said step of calculating an efficiency value for each slave communication device comprises calculating an efficiency value based, at least in part, on at least one of the presence of data to send from said master communication device to a slave communication device, and either a traffic demand message sent from a slave communication device to the master communication device or an estimate of the probability that a slave communication device has data to send to the master communication device.

12. The method of claim 8, wherein said step of calculating a fairness value for each slave communication device comprises calculating a fairness value based on a predetermined definition of fairness.

13. The method of claim 11, wherein said predetermined definition of fairness includes agreed to Quality of Service requirements.

14. The method of claim 9, wherein said master communication device and said plurality of slave communication devices comprise a piconet in a Bluetooth communication system.

15. A system for controlling access to a communication channel, comprising:
a primary communication device; and
a plurality of secondary communication devices, said primary communication device operable to:
calculate an efficiency value for each of said secondary communication devices;
calculate a fairness value for each of said secondary communication devices; and
select a first communication device from said plurality of secondary communication devices to be provided access to said communication channel based on a result of said calculated efficiency value and said calculated fairness value.

16. The system of claim 15, wherein said primary communication device comprises a master communication device, said plurality of secondary communication devices comprises a plurality of slave communication devices, and wherein said first communication device is selected by polling said first communication device.

17. The system of claim 16, wherein said master communication device includes a slave selector for selecting said first slave communication device.

18. The system of claim 16, wherein said slave selector includes:
a fair share determinator for determining a fair share of bandwidth for at least one of said plurality of slave communication devices;
a decision maker for determining said next slave communication device to be polled out of said plurality of slave communication devices; and
at least one slave status tracker for transmitting, to said decision maker, a fraction of said fair share of bandwidth and a probability of data being available to transmit for said at least one of said plurality of slave communication devices.

19. The system of claim 18, wherein said at least one slave status tracker further comprises:
a fraction of fair share estimator for estimating said fraction of said fair share of bandwidth;
a data availability predictor for predicting said probability of data being available to transmit for said at least one of said plurality of slave communication devices; and
a traffic demand estimator for estimating a traffic demand for at least one of said at least one slave status tracker.

20. The system of claim 16, wherein said system comprises a Bluetooth communication system.

21. A master device for controlling at least one slave device in a communication system, said master device comprising:
a slave selector for predicting a next slave device from a plurality of slave devices to be polled, said slave selector comprising:
a fair share determinator for determining a fair share of bandwidth for at least one of said plurality of slaves devices;
a decision maker for determining said next slave device to be polled out of said plurality of slave devices; and
at least one slave status tracker for transmitting, to said decision maker, a fraction of said fair share of bandwidth and a probability of data being available to transmit for said at least one of said plurality of slave devices.

22. The master device of claim 21, wherein said at least one slave status tracker further comprises:
a fraction of fair share estimator for estimating said fraction of said fair share of bandwidth;
a data availability predictor for predicting said probability of data being available to transmit for said at least one of said plurality of slave devices; and
a traffic demand estimator for estimating a traffic demand for at least one of said at least one slave status tracker.
